(19) United States
(12) Patent Application Publication
(10) Pub. No.: US 2025/0094860 A1
(43) Pub. Date: Mar. 20, 2025

(54) EMERGING INDUSTRY PREDICTION USING MACHINE LEARNING

(71) Applicant: S&P Global Inc., New York, NY (US)

(72) Inventors: Rajesh Iyer, Kendall Park, NJ (US); Shamik Banerjee, Plainsboro, NJ (US); Bhumit Mody, Millburn, NJ (US); Vibudh Singh, Calgary (CA); Akanksha Agarwal, Pickering (CA); Ronak Patel, East Windsor, NJ (US); Nuria Donadomera, San Jose, CA (US); Kunala Sarat Kumar, Monmouth Junction, NJ (US); Riju Jacob, Saskatoon (CA); Sanjay Kushwah, Navi Mumbai (IN)

(21) Appl. No.: 18/469,030

(22) Filed: Sep. 18, 2023

(51) Int. Cl. G06N 20/00

(52) U.S. Cl. CPC G06N 20/00

(57) ABSTRACT

A method for training a machine learning model for categorizing data is provided. The method comprising receiving labeled positive training data and negative training data. The positive training data and negative training data are lemmatized and then vectorizing the lemmatized into a vector space. A machine learning model is trained with the vectorized positive training data and negative training data to identify a new category of data from existing categories in the positive training data and negative training data.

### BACKGROUND INFORMATION

### 1. Field

The present disclosure relates generally to an improved computing system, and more specifically to a method of using machine learning to predict the emergence of new industries from existing industries.

### 2. Background

Emerging industries comprise industries that are in the early stages of development, often within currently established industries and sectors. Emerging industries are often characterized by new technologies, products, or services. Examples include artificial intelligence, renewable energy, and blockchain technology.

Therefore, it would be desirable to have a method and apparatus that takes into account at least some of the issues discussed above, as well as other possible issues.

### SUMMARY

An illustrative embodiment provides a computer-implemented method for training a machine learning model for categorizing data. The method comprising receiving labeled positive training data and negative training data. The positive training data and negative training data are lemmatized and then vectorizing the lemmatized into a vector space. A machine learning model is trained with the vectorized positive training data and negative training data to identify a new category of data from existing categories in the positive training data and negative training data.

Another illustrative embodiment provides a system for training a machine learning model for categorizing data. The system comprises a storage device that stores program instructions and one or more processors operably connected to the storage device and configured to execute the program instructions to cause the system to: receive labeled positive training data; receive negative training data; lemmatize the positive training data and negative training data; vectorize the lemmatized positive training data and negative training data into a vector space; and train a machine learning model, with the vectorized positive training data and negative training data, to identify a new category of data from existing categories in the positive training data and negative training data.

Another illustrative embodiment provides a computer program product for training a machine learning model for categorizing data. The computer program product comprises a computer-readable storage medium having program instructions embodied thereon to perform the steps of: receiving labeled positive training data; receiving negative training data; lemmatizing the positive training data and negative training data; vectorizing the lemmatized positive training data and negative training data into a vector space; training a machine learning model, with the vectorized positive training data and negative training data, to identify a new category of data from existing categories in the positive training data and negative training data.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is a pictorial representation of a network of data processing systems in which illustrative embodiments may be implemented;

FIG. 2 is a block diagram of a categorization system depicted in accordance with an illustrative embodiment;

FIG. 3 depicts a machine learning process for industry classification model training in accordance with an illustrative embodiment;

FIG. 4 depicts an alternate machine learning process for industry classification model training in accordance with an illustrative embodiment;

FIG. 5 depicts a flowchart illustrating a process for training a machine learning model for categorizing data in accordance with an illustrative embodiment;

FIG. 6 depicts a flowchart illustrating a process for training the machine learning model in accordance with an illustrative embodiment;

FIG. 7 depicts a flowchart illustrating an alternate process for training the machine learning model in accordance with an illustrative embodiment;

FIG. 8 depicts a flowchart illustrating a process for enhancing training the machine learning model in accordance with an illustrative embodiment; and

FIG. 9 is a block diagram of a data processing system in accordance with an illustrative embodiment.

### DETAILED DESCRIPTION

The illustrative embodiments recognize and take into account that it is challenging to identify and categorize relevant companies into emerging industries within the context of current industries and established terminology and classifications of industries and sectors. The illustrative embodiments recognizes that emerging industries often give rise to a multitude of sub-sectors and niche markets, which cater to specific needs and demands within the larger framework. These sectors may include manufacturing, research and development, marketing, distribution, and services, among others. As various companies become players in an emerging industry, prospects for these companies improve and they become more attractive to investors and potential partners.

The illustrative embodiments provide an industry ecosystem approach adapted with machine learning models to identify relevant companies for various emerging industries. Based on evidence of collaboration and interaction among companies in an emerging industry's ecosystem, terms are used to describe the various players. At their early stages, developments of emerging industries are often unstable and contingent. Thus, terms are often contingent and dynamic. Dynamic ecosystem terms may also be gathered through machine learning models which are trained on known industries and are applied to the ecosystem of an emerging industry. Such terms are used to train models for label companies with each emerging industry. In addition, a verification mechanism is implemented to ensure model accuracy and reliability.

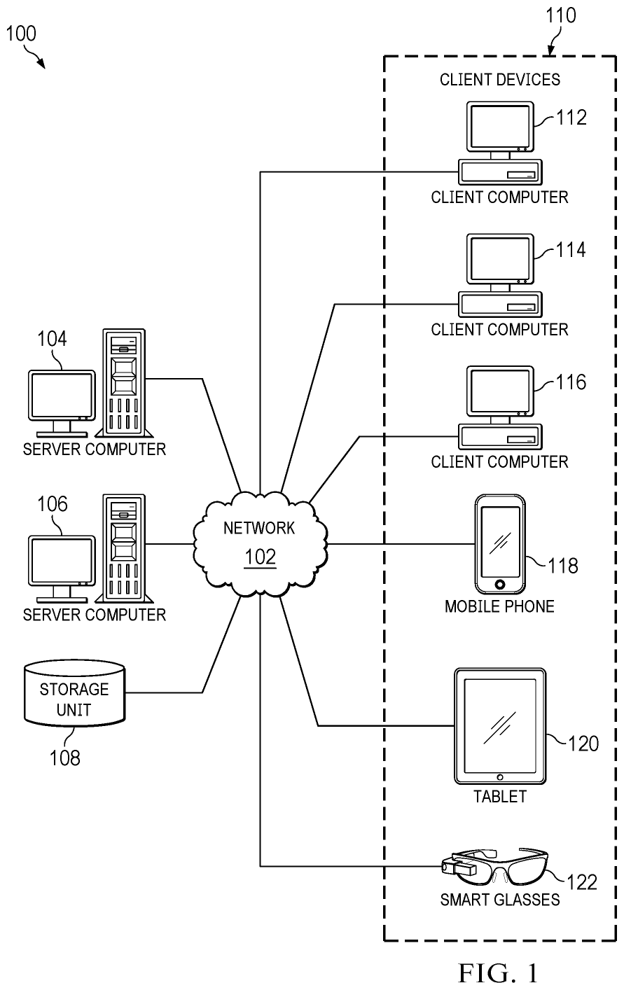

With reference to FIG. 1, a pictorial representation of a network of data processing systems is depicted in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 might include connections, such as wire, wireless communication links, or fiber optic cables.

In the depicted example, server computer 104 and server computer 106 connect to network 102 along with storage unit 108. In addition, client devices 110 connect to network 102. In the depicted example, server computer 104 provides information, such as boot files, operating system images, and applications to client devices 110. Client devices 110 can be, for example, computers, workstations, or network computers. As depicted, client devices 110 includes client computers 112, 114, and 116. Client devices 110 can also include other types of client devices such as mobile phone 118, tablet computer 120, and smart glasses 122.

In this illustrative example, server computer 104, server computer 106, storage unit 108, and client devices 110 are network devices that connect to network 102 in which network 102 is the communications media for these network devices. Some or all of client devices 110 may form an Internet of things (IoT) in which these physical devices can connect to network 102 and exchange information with each other over network 102.

Client devices 110 are clients to server computer 104 in this example. Network data processing system 100 may include additional server computers, client computers, and other devices not shown. Client devices 110 connect to network 102 utilizing at least one of wired, optical fiber, or wireless connections.

Program code located in network data processing system 100 can be stored on a computer-recordable storage medium and downloaded to a data processing system or other device for use. For example, the program code can be stored on a computer-recordable storage medium on server computer 104 and downloaded to client devices 110 over network 102 for use on client devices 110.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, governmental, educational, and other computer systems that route data and messages. Of course, network data processing system 100 also may be implemented using a number of different types of networks. For example, network 102 can be comprised of at least one of the Internet, an intranet, a local area network (LAN), a metropolitan area network (MAN), or a wide area network (WAN). FIG. 1 is intended as an example, and not as an architectural limitation for the different illustrative embodiments.

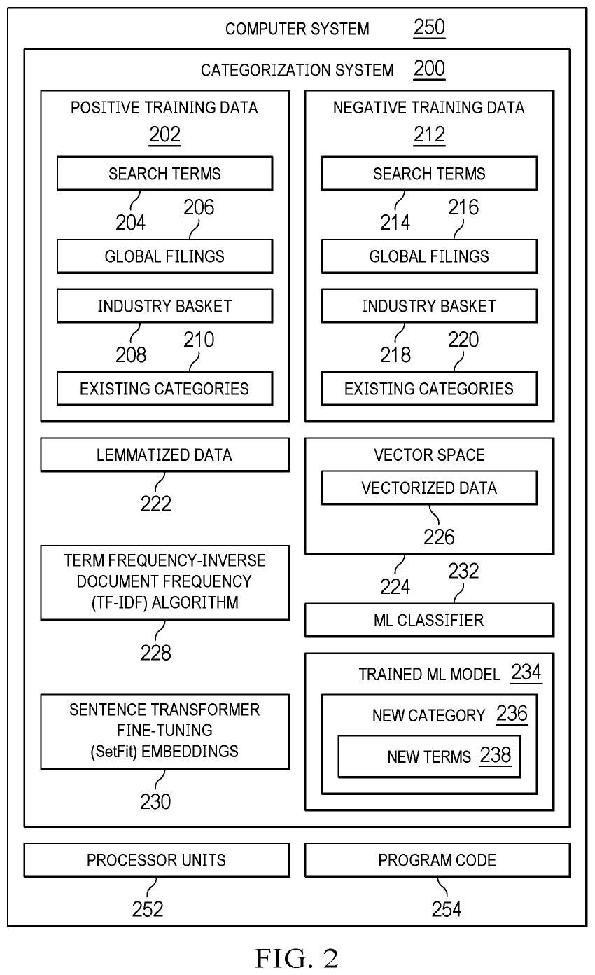

FIG. 2 is a block diagram of a categorization system depicted in accordance with an illustrative embodiment. Categorization system 200 might be implemented in network data processing system 100 in FIG. 1.

Categorization system 200 utilizes positive training data 202 and negative training data 212. Positive training data 202 includes data that is relevant to a topic of interest. Positive training data 202 may be derived from global filings 206, for example, with financial authorities such as the U.S. Securities and Exchange Commission (SEC) and similar regulatory bodies. Positive training data 202 comprises a number of search terms 204 related to the topic of interest. Positive training data 202 may be related to a specific industry basket 208. An industry basket refers to a grouping of companies that operate within a particular industry or sector that share similar characteristics such products or services sold, target markets, etc. Examples of industry baskets include telecommunications, automotive, healthcare, finance, etc. Positive training data 202 may fall into a number of existing categories 210 related to industries in the industry basket 208.

Negative training data 212 includes data that is unrelated to the topic of interest. Negative training data 212 may be derived from global filings 216 and includes search terms 214 that are similar the search terms 204 in the positive training data 202 but are used within a completely different context unrelated to the topic of interest. Negative training data 212 is drawn from a different industry basket 218 than that of positive training data 202. Similarly, negative training data 212 can be subsumed under existing categories 220 of data. Negative training data 212 helps the categorization system 200 learn alternate uses of similar terminology that are not related to the topic of interest and thereby reduce false positives.

Both positive training data 202 and negative training data 212 are combined into lemmatized data 222 wherein different inflected forms of a given word are combined for analysis as a single term.

The lemmatized data 222 is vectorized in vector space 224 to form vectorized data 226. Term frequency-Inverse document frequency (TF-IDF) algorithm 228 may be applied to vectorized data 226. Categorization system 200 may also feed sentence transformation fine-tuning (SetFit) embeddings 230 into TF-IDF algorithm 228.

A machine learning (ML) classifier 232 learns vectorized data 226 to produce a trained ML model 234 capable of identifying a new category 236 of data from the positive training data 202. For example, new category 236 might comprise a previously unrecognized or unclassified industry or sector emerging from within currently defined industries as a result of innovation. Furthermore, trained ML 234 may identify a number of new terms 238 related to the new category 236 that can be used to identify companies in the emerging industry.

Categorization system 200 can be implemented in software, hardware, firmware, or a combination thereof. When software is used, the operations performed by categorization system 200 can be implemented in program code configured to run on hardware, such as a processor unit. When firmware is used, the operations performed by categorization system 200 can be implemented in program code and data and stored in persistent memory to run on a processor unit. When hardware is employed, the hardware can include circuits that operate to perform the operations in categorization system 200.

In the illustrative examples, the hardware can take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

Computer system 250 is a physical hardware system and includes one or more data processing systems. When more than one data processing system is present in computer system 250, those data processing systems are in communication with each other using a communications medium. The communications medium can be a network. The data processing systems can be selected from at least one of a computer, a server computer, a tablet computer, or some other suitable data processing system.

As depicted, computer system 250 includes a number of processor units 252 that are capable of executing program code 254 implementing processes in the illustrative examples. As used herein, a processor unit in the number of processor units 252 is a hardware device and is comprised of hardware circuits such as those on an integrated circuit that respond and process instructions and program code that operate a computer. When a number of processor units 252 execute program code 254 for a process, the number of processor units 252 is one or more processor units that can be on the same computer or on different computers. In other words, the process can be distributed between processor units on the same or different computers in a computer system. Further, the number of processor units 252 can be of the same type or different type of processor units. For example, a number of processor units can be selected from at least one of a single core processor, a dual-core processor, a multi-processor core, a general-purpose central processing unit (CPU), a graphics processing unit (GPU), a digital signal processor (DSP), or some other type of processor unit.

Machine learning involves using machine learning algorithms to build machine learning models based on samples of data. The samples of data used for training referred to as training data or training datasets. Machine learning models trained using training datasets and make predictions without being explicitly programmed to make these predictions. Machine learning models can be trained for a number of different types of applications. These applications include, for example, medicine, healthcare, speech recognition, computer vision, or other types of applications.

These machine learning algorithms can include supervised machine learning algorithms and unsupervised machine learning algorithms. Supervised machine learning can train machine learning models using data containing both the inputs and desired outputs. Examples of machine learning algorithms include XGBoost, K-means clustering, and random forest.

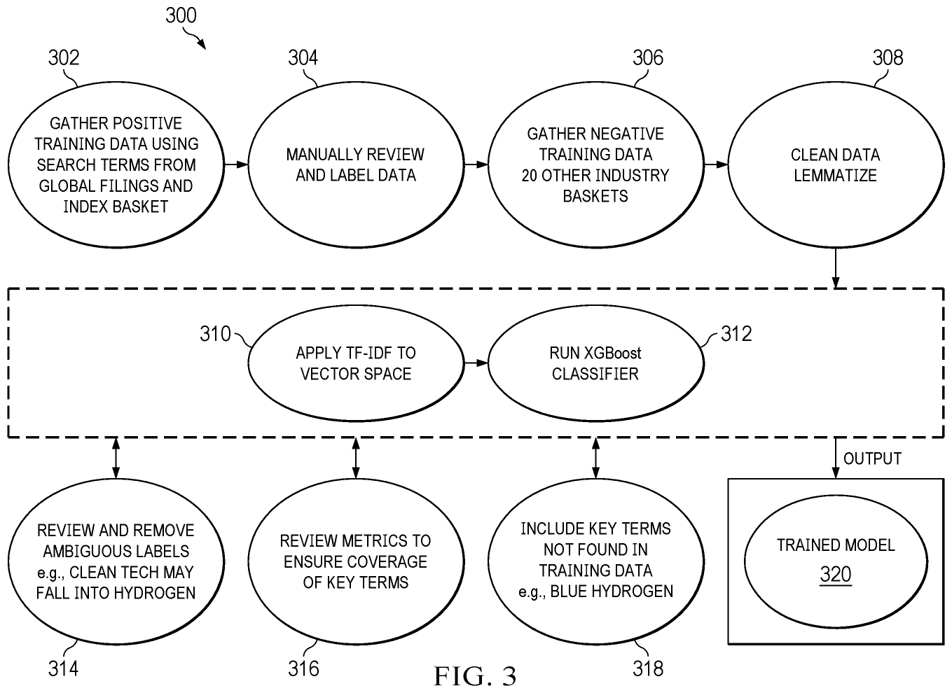

FIG. 3 depicts a machine learning process for industry classification model training in accordance with an illustrative embodiment. Process 300 can be implemented in categorization system 200 in FIG. 2.

During step 302, positive training data is gathered using search terms from global filings and an industry index basket (e.g., automotive industry). This positive training is manually reviewing and labeling the positive training data in step 304.

In addition to the positive training data, step 306 gathers negative training data from a number (e.g., 20) of other industry baskets. Because the negative training data is drawn from other industry baskets, the machine learning process can better learn how similar search terms might be used to different contexts unrelated to the industry basket from which the positive training data is drawn. In other words, the negative training data helps the machine learning process learn what to ignore.

In step 308 the positive and negative training data is cleaned and lemmatized. Cleaning identifies and corrects errors and inconsistencies in the training data to improve the quality of machine learning. For example, cleaning might include removing duplicates, deleting, or filling in missing values, etc. Lemmatization reduces the number of unique words in the text and can assist natural language processing understand the intended meaning of words within context as well as compare words with similar meaning.

In the present example, the cleaned, lemmatized training data is vectorized and fed into a TF-IDF algorithm in step 310. The TF-IDF algorithm is a statistical measure regarding the importance of a term in a group of documents and can be used to determine the relevance of a document to a specific topic of interest. Term frequency (TF) measures the frequency with which a term appears in a given document, and inverse document frequency (IDF) measures how rare the term is across a number of documents.

Step 314 might enhance the TF-IDF algorithm by reviewing and removing ambiguous label. For example, a label such as “clean technology” might fall under a more definite category such as hydrogen.

After application of the TF-IDF algorithm, the training data is fed into a machine learning classifier in step 312. The classifier might be, for example, XGBoost. During the machine learning process, metrics produced by the classifier might be reviewed in step 316 to ensure coverage of key terms. In addition, step 318 may add key terms of interest not found in the training data.

The end result of the machine learning process 300 is a trained model 320 that is able to identify a new category of data from existing categories. An example of a specific use case is the identification of new industries emerging from existing industries but have not yet been formally classified as recognized, standalone industries (i.e., do not yet have widely accepted names/labels).

The illustrative embodiments can focus on innovation in particular sectors or industries and identify all companies that contribute to the ecosystem for such a product (e.g., enabling an industry-providing infrastructure). The complex ecosystem for the emerging industry may comprise various sectors, such as manufacturing, technology, finance, and services, which are linked through a web of supply chains and collaborative partnerships.

After an emerging industry becomes established and its various sectors become standard, it becomes a standard industry, and the emerging industry category label is removed. When the next new emerging industry appears, companies of the standard industry may yet again be recruited as part of the new emerging industry for performing different functions.

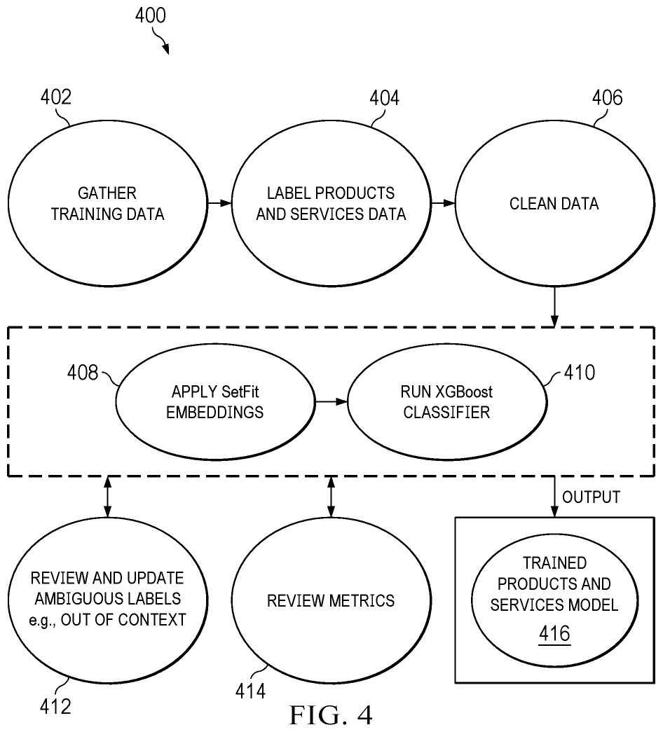

FIG. 4 depicts an alternate machine learning process for industry classification model training in accordance with an illustrative embodiment. Process 400 can be implemented in categorization system 200 in FIG. 2.

Process 400 is similar to process 300 in FIG. 3, differing primarily in the machine learning steps. Similar to process 300, process 400 comprises gathering positive training data in step 402, which is then manually labeled to identify products and services data in step 404. Though not shown in FIG. 4, process 400 can also include gathering negative training data. The training data is cleaned and lemmatized in step 406.

After vectorizing the cleaned training data into a vector space, process 400 applies SetFit embeddings to a key term search using proximity in step 408. The SetFit embeddings adapt a pre-trained model to a specific task or domain by further training the model on a specific dataset to optimize the pre-trained model's parameters to the specific task at hand. For example, the SetFit embeddings can identify datasets that are in the products and services space of a company.

Proximity analysis is used to determine the similarity between data points. Proximity analysis allows grouping of similar data points and separating of dissimilar data points. Proximity analysis can also facilitate detection of anomalies (i.e., outlier data points).

It should be noted that, optionally, SetFit embeddings can also be applied in process 300 before the training data is fed into the TF-IDF algorithm.

Ambiguous label in the dataset may be reviewed and updated in step 412 to enhance the SetFit application.

The results of the term search are fed into a machine learning classifier such as XGBoost in step 410. As in process 300, metrics produced by the classifier might be reviewed to ensure coverage of key terms, and any key terms missing from the training data can be added in step 414.

The end result of the machine learning process 400 is a trained model 416 that is able to identify a new category of data from existing categories.

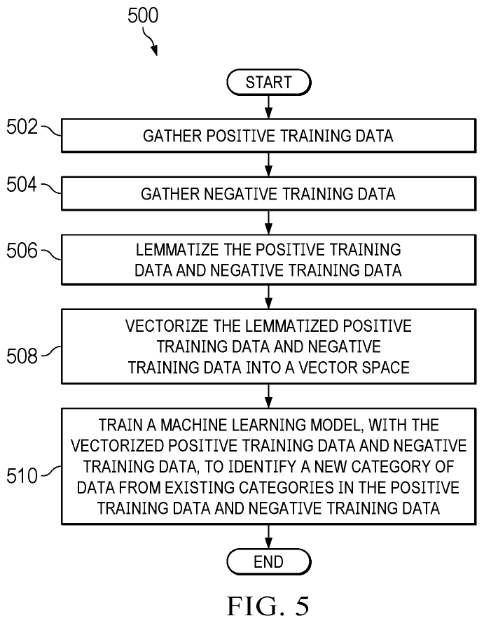

FIG. 5 depicts a flowchart illustrating a process for training a machine learning model for categorizing data in accordance with an illustrative embodiment. Process 500 might be implemented in categorization system 200 in FIG. 2.

Process 500 begins by receiving labeled positive training data (step 502) and receiving negative training data (step 504).

The positive training data and negative training data are lemmatized (step 506), and the lemmatized positive training data and negative training data are vectorized into a vector space (step 508).

A machine learning model is trained with the vectorized positive training data and negative training data to identify a new category of data from existing categories in the positive training data and negative training data (step 510). The machine learning model might identify a number of new terms related to the new category of data. These new terms may be associated with a number of companies in an emerging industry. Process 500 then ends.

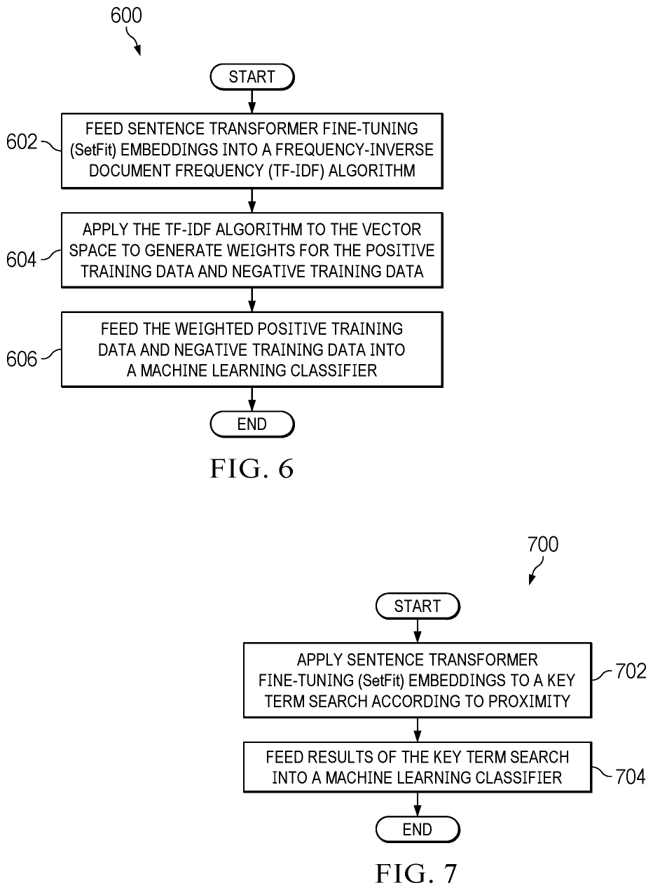

FIG. 6 depicts a flowchart illustrating a process for training the machine learning model in accordance with an illustrative embodiment. Process 600 is a detailed example of step 510 in FIG. 5.

Process 600 begins by feeding sentence SetFit embeddings into a TF-IDF algorithm (step 602). The TF-IDF algorithm is then applied to the vector space to generate weights for the positive training data and negative training data for the machine learning models (step 604). The weighted positive training data and negative training data are then fed into a machine learning classifier (step 606). Process 600 then ends.

FIG. 7 depicts a flowchart illustrating an alternate process for training the machine learning model in accordance with an illustrative embodiment. Process 700 is an alternated detailed example of step 510 in FIG. 5.

Process 700 beings by applying sentence transformer fine-tuning (SetFit) embeddings directly to a key term search according to proximity (step 702). The results of the key term search are then fed into the machine learning classifier (step 704). Process 700 then ends.

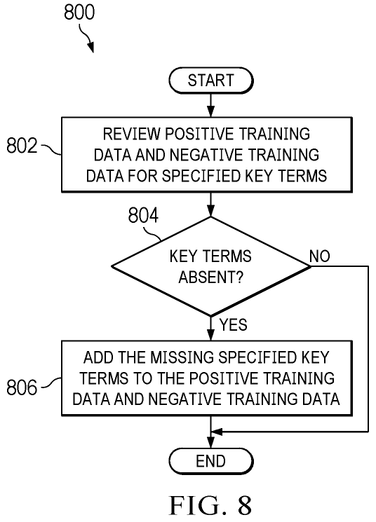

FIG. 8 depicts a flowchart illustrating a process for enhancing training the machine learning model in accordance with an illustrative embodiment. Process 800 comprises additional steps that can be performed as part of step 510 in FIG. 5.

Process 800 begins by reviewing positive training data and negative training data for specified key terms (step 802). Responsive to a determination any of the specified key terms are missing from the positive training data and negative training data (step 804), adding the missing specified key terms are added to the positive training data and negative training data (step 806). Process 800 then ends.

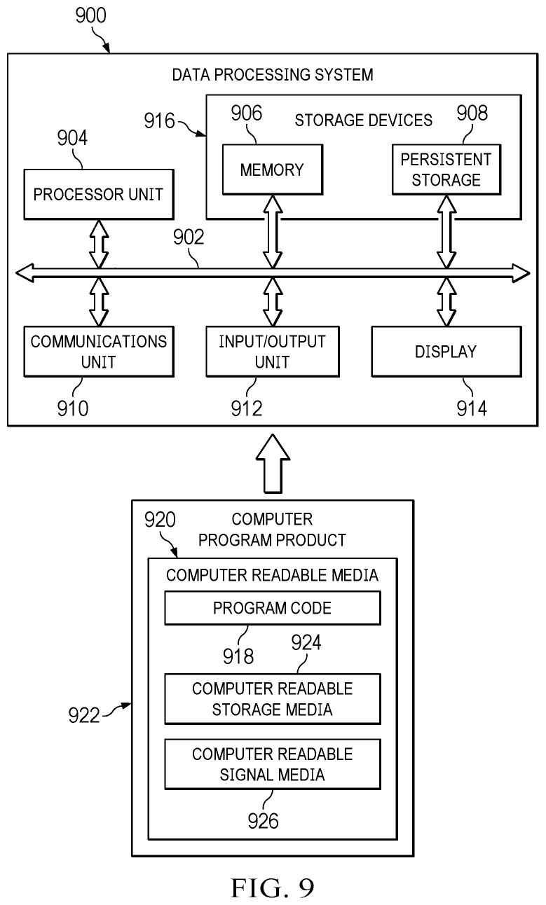

Turning now to FIG. 9, an illustration of a block diagram of a data processing system is depicted in accordance with an illustrative embodiment. Data processing system 900 may be used to implement server computer 104 and server computer 106 and client devices 110 in FIG. 1, as well as computer system 250 in FIG. 2. In this illustrative example, data processing system 900 includes communications framework 902, which provides communications between processor unit 904, memory 906, persistent storage 908, communications unit 910, input/output unit 912, and display 914. In this example, communications framework 902 may take the form of a bus system.

Processor unit 904 serves to execute instructions for software that may be loaded into memory 906. Processor unit 904 may be a number of processors, a multi-processor core, or some other type of processor, depending on the particular implementation. In an embodiment, processor unit 904 comprises one or more conventional general-purpose central processing units (CPUs). In an alternate embodiment, processor unit 904 comprises one or more graphical processing units (GPUS).

Memory 906 and persistent storage 908 are examples of storage devices 916. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 916 may also be referred to as computer-readable storage devices in these illustrative examples. Memory 906, in these examples, may be, for example, a random access memory or any other suitable volatile or non-volatile storage device. Persistent storage 908 may take various forms, depending on the particular implementation.

For example, persistent storage 908 may contain one or more components or devices. For example, persistent storage 908 may be a hard drive, a flash memory, a rewritable optical disk, a rewritable magnetic tape, or some combination of the above. The media used by persistent storage 908 also may be removable. For example, a removable hard drive may be used for persistent storage 908. Communications unit 910, in these illustrative examples, provides for communications with other data processing systems or devices. In these illustrative examples, communications unit 910 is a network interface card.

Input/output unit 912 allows for input and output of data with other devices that may be connected to data processing system 900. For example, input/output unit 912 may provide a connection for user input through at least one of a keyboard, a mouse, or some other suitable input device. Further, input/output unit 912 may send output to a printer. Display 914 provides a mechanism to display information to a user.

Instructions for at least one of the operating system, applications, or programs may be located in storage devices 916, which are in communication with processor unit 904 through communications framework 902. The processes of the different embodiments may be performed by processor unit 904 using computer-implemented instructions, which may be located in a memory, such as memory 906.

These instructions are referred to as program code, computer-usable program code, or computer-readable program code that may be read and executed by a processor in processor unit 904. The program code in the different embodiments may be embodied on different physical or computer-readable storage media, such as memory 906 or persistent storage 908.

Program code 918 is located in a functional form on computer-readable media 920 that is selectively removable and may be loaded onto or transferred to data processing system 900 for execution by processor unit 904. Program code 918 and computer-readable media 920 form computer program product 922 in these illustrative examples. In one example, computer-readable media 920 may be computer-readable storage media 924 or computer-readable signal media 926.

In these illustrative examples, computer-readable storage media 924 is a physical or tangible storage device used to store program code 918 rather than a medium that propagates or transmits program code 918. Computer readable storage media 924, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program code 918 may be transferred to data processing system 900 using computer-readable signal media 926. Computer-readable signal media 926 may be, for example, a propagated data signal containing program code 918. For example, computer-readable signal media 926 may be at least one of an electromagnetic signal, an optical signal, or any other suitable type of signal. These signals may be transmitted over at least one of communications links, such as wireless communications links, optical fiber cable, coaxial cable, a wire, or any other suitable type of communications link.

The different components illustrated for data processing system 900 are not meant to provide architectural limitations to the manner in which different embodiments may be implemented. The different illustrative embodiments may be implemented in a data processing system including components in addition to or in place of those illustrated for data processing system 900. Other components shown in FIG. 9 can be varied from the illustrative examples shown. The different embodiments may be implemented using any hardware device or system capable of running program code 918.

As used herein, “a number of,” when used with reference to items, means one or more items. For example, “a number of different types of networks” is one or more different types of networks.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combinations of these items can be present. In some illustrative examples, “at least one of” can be, for example, without limitation, two of item A; one of item B; and ten of item C; four of item B and seven of item C; or other suitable combinations.

The flowcharts and block diagrams in the different depicted embodiments illustrate the architecture, functionality, and operation of some possible implementations of apparatuses and methods in an illustrative embodiment. In this regard, each block in the flowcharts or block diagrams can represent at least one of a module, a segment, a function, or a portion of an operation or step. For example, one or more of the blocks can be implemented as program code, hardware, or a combination of the program code and hardware. When implemented in hardware, the hardware may, for example, take the form of integrated circuits that are manufactured or configured to perform one or more operations in the flowcharts or block diagrams. When implemented as a combination of program code and hardware, the implementation may take the form of firmware. Each block in the flowcharts or the block diagrams may be implemented using special purpose hardware systems that perform the different operations or combinations of special purpose hardware and program code run by the special purpose hardware.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

The different illustrative examples describe components that perform actions or operations. In an illustrative embodiment, a component may be configured to perform the action or operation described. For example, the component may have a configuration or design for a structure that provides the component with an ability to perform the action or operation that is described in the illustrative examples as being performed by the component.

Many modifications and variations will be apparent to those of ordinary skill in the art. Further, different illustrative embodiments may provide different features as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A computer-implemented method for training a machine learning model for categorizing data, the method comprising:
receiving labeled positive training data;
receiving negative training data;
lemmatizing the positive training data and negative training data;
vectorizing the lemmatized positive training data and negative training data into a vector space; and
training a machine learning model, with the vectorized positive training data and negative training data, to identify a new category of data from existing categories in the positive training data and negative training data.

2. The method of claim 1, wherein training the machine learning model comprises:
applying a term frequency-inverse document frequency (TF-IDF) algorithm to the vector space to generate weights for the positive training data and negative training data; and
feeding the weighted positive training data and negative training data into a machine learning classifier.

3. The method of claim 2, wherein applying the TF-IDF further comprises feeding sentence transformer fine-tuning (SetFit) embeddings into the TF-IDF algorithm.

4. The method of claim 1, wherein training the machine learning model comprises:
applying sentence transformer fine-tuning (SetFit) embeddings to a key term search according to proximity; and
feeding results of the key term search into a machine learning classifier.

5. The method of claim 1, further comprising removing ambiguous labels from the positive training data and negative training data.

6. The method of claim 1, wherein training the machine learning model further comprises reviewing positive training data and negative training data for specified key terms.

7. The method of claim 6, further comprising, responsive to a determination any of the specified key terms are missing from the positive training data and negative training data, adding the missing specified key terms to the positive training data and negative training data.

8. The method of claim 1, wherein the machine learning model comprises an XGBoost classifier.

9. The method of claim 1, wherein the positive training data comprises search terms from global filings and an industry basket.

10. The method of claim 1, wherein the negative training data comprises search terms from global filings and other industry baskets.

11. The method of claim 1, wherein the machine learning model identifies a number of new terms related to the new category of data.

12. The method of claim 11, wherein the new terms are associated with a number of companies in an emerging industry.

13. A system for training a machine learning model for categorizing data, the system comprising:
a storage device that stores program instructions;
one or more processors operably connected to the storage device and configured to execute the program instructions to cause the system to:
receive labeled positive training data;
receive negative training data;
lemmatize the positive training data and negative training data;
vectorize the lemmatized positive training data and negative training data into a vector space; and
train a machine learning model, with the vectorized positive training data and negative training data, to identify a new category of data from existing categories in the positive training data and negative training data.

14. The system of claim 13, wherein training the machine learning model comprises the processors executing instructions to cause the system to:
apply a term frequency-inverse document frequency (TF-IDF) algorithm to the vector space to generate weights for the positive training data and negative training data; and
feed the weighted positive training data and negative training data into a machine learning classifier.

15. The system of claim 14, wherein applying the TF-IDF further comprises the processors executing instructions to cause the system to feed sentence transformer fine-tuning (SetFit) embeddings into the TF-IDF algorithm.

16. The system of claim 13, wherein training the machine learning model comprises the processors executing instructions to cause the system to:
apply sentence transformer fine-tuning (SetFit) embeddings to a key term search according to proximity; and
feed results of the key term search into a machine learning classifier.

17. The system of claim 13, wherein the processors further execute instructions to cause the system to remove ambiguous labels from the positive training data and negative training data.

18. The system of claim 13, wherein training the machine learning model further comprises the processors executing instructions to cause the system to review positive training data and negative training data for specified key terms.

19. The system of claim 18, further comprising, responsive to a determination any of the specified key terms are missing from the positive training data and negative training data, adding the missing specified key terms to the positive training data and negative training data.

20. The system of claim 13, wherein the machine learning model comprises an XGBoost classifier.

21. The system of claim 13, wherein the positive training data comprises search terms from global filings and an industry basket.

22. The system of claim 13, wherein the negative training data comprises search terms from global filings and other industry baskets.

23. The system of claim 13, wherein the machine learning model identifies a number of new terms related to the new category of data.

24. The system of claim 23, wherein the new terms are associated with a number of companies in an emerging industry.

25. A computer program product for training a machine learning model for categorizing data, the computer program product comprising:
a computer-readable storage medium having program instructions embodied thereon to perform the steps of:
receiving labeled positive training data;
receiving negative training data;
lemmatizing the positive training data and negative training data;
vectorizing the lemmatized positive training data and negative training data into a vector space; and
training a machine learning model, with the vectorized positive training data and negative training data, to identify a new category of data from existing categories in the positive training data and negative training data.

26. The computer program product of claim 25, wherein training the machine learning model comprises instructions for:
applying a term frequency-inverse document frequency (TF-IDF) algorithm to the vector space to generate weights for the positive training data and negative training data; and
feeding the weighted positive training data and negative training data into a machine learning classifier.

27. The computer program product of claim 26, wherein applying the TF-IDF further comprises instructions for feeding sentence transformer fine-tuning (SetFit) embeddings into the TF-IDF algorithm.

28. The computer program product of claim 25, wherein training the machine learning model comprises instructions for:
applying sentence transformer fine-tuning (SetFit) embeddings to a key term search according to proximity; and
feeding results of the key term search into a machine learning classifier.

29. The computer program product of claim 25, further comprising instructions for removing ambiguous labels from the positive training data and negative training data.

30. The computer program product of claim 25, wherein training the machine learning model further comprises instructions for reviewing positive training data and negative training data for specified key terms.

31. The computer program product of claim 30, further comprising instructions for, responsive to a determination any of the specified key terms are missing from the positive training data and negative training data, adding the missing specified key terms to the positive training data and negative training data.

32. The computer program product of claim 25, wherein the machine learning model comprises an XGBoost classifier.

33. The computer program product of claim 25, wherein the positive training data comprises search terms from global filings and an industry basket.

34. The computer program product of claim 25, wherein the negative training data comprises search terms from global filings and other industry baskets.

35. The computer program product of claim 25, wherein the machine learning model identifies a number of new terms related to the new category of data.

36. The computer program product of claim 35, wherein the new terms are associated with a number of companies in an emerging industry.
